(19) United States
(12) Patent Application Publication
(10) Pub. No.: US 2017/0285389 A1
(43) Pub. Date: Oct. 5, 2017

(54) LIQUID CRYSTAL DISPLAY DEVICE AND METHOD FOR MANUFACTURING SAME

(71) Applicant: Panasonic Liquid Crystal Display Co., Ltd., Himeji-shi (JP)

(72) Inventors: Seiji NISHITANI, Kyoto (JP); Koji MIMURA, Kanagawa (JP)

(21) Appl. No.: 15/625,665

(22) Filed: Jun. 16, 2017

Related U.S. Application Data
(63) Continuation of application No. PCT/JP2015/006153, filed on Dec. 9, 2015.

(30) Foreign Application Priority Data
Dec. 18, 2014 (JP) 2014-256110

(51) Int. Cl. G02F 1/1339; G02F 1/1343; G02F 1/1337; G02F 1/1362

(52) U.S. Cl. CPC G02F 1/13394; G02F 1/136286; G02F 1/134336; G02F 1/133788; G02F 2201/123; G02F 2201/121

(57) ABSTRACT

A liquid crystal display device includes: a first substrate including a gate line, a data line, a pixel electrode, a common electrode, and a photo-alignment film; a second substrate including a photo-alignment film; a liquid crystal layer including a negative liquid crystal molecule; and a spacer that keeps an interval between the substrates constant. The first substrate and the second substrate are formed such that a rate of change is larger than 6.25% in the spacer, the rate of change indicating a rate of an amount of change to a reference height, the amount of change indicating a difference between the reference height and a height after pushing and bonding of the first substrate and the second substrate to each other, the reference height indicating an original height before bonding of the first substrate and the second substrate to each other.

### CROSS-REFERENCE TO RELATED APPLICATION

This application is a bypass continuation of international patent application PCT/JP2015/006153, filed Dec. 9, 2015 designating the United States of America. Priority is claimed based on Japanese patent application JP2014-256110, filed Dec. 18, 2014. The entire disclosures of these international and Japanese patent applications are incorporated herein by reference in their entirety.

### TECHNICAL FIELD

The present disclosure relates to a liquid crystal display device and a manufacturing method thereof.

### BACKGROUND

Among various liquid crystal display devices, an IPS (In Plane Switching)-system liquid crystal display device is excellent in a wide viewing angle characteristic. For example, in the IPS-system liquid crystal display device, a pixel electrode and a common electrode are provided in one of a pair of substrates which are disposed opposite to each other with crystal liquid interposed therebetween. In the configuration of the IPS-system liquid crystal display device, an electric field (transverse electric field) parallel to a substrate is generated between the pixel electrode and the common electrode, and the transverse electric field is applied to liquid crystal to drive the liquid crystal. Therefore, an image is displayed by control of an amount of light transmitted through a liquid crystal layer.

A technology of performing a photo-alignment treatment on an alignment film has been proposed in the IPS-system liquid crystal display device (for example, see, Japanese Unexamined Patent Application Publication No. 2011-170031). In recent years, a technology of using a photo-alignment film and negative liquid crystal in the IPS-system liquid crystal display device has been proposed. Reduction of afterimage and improvement of a transmittance can be achieved in the IPS-system liquid crystal display device in which the photo-alignment film and the negative liquid crystal are used.

However, in the IPS-system liquid crystal display device in which the photo-alignment film and the negative liquid crystal are used, there is a problem in that a bright spot is generated in a display region when a predetermined temperature cycle (for example, room temperature→high temperature→low temperature→room temperature) test is repeated. For example, the temperature cycle is performed in a display panel test process.

An object of the present disclosure is to suppress the bright spot generation caused by the performance of the predetermined temperature cycle in the IPS-system liquid crystal display device in which the photo-alignment film and the negative liquid crystal are used.

### SUMMARY

In one general aspect, the instant application describes a liquid crystal display device including a first substrate including a plurality of gate lines extending in a row direction, a plurality of data lines extending in a column direction, a plurality of pixel electrodes each of which is disposed according to each of a plurality of pixel regions arrayed in the row direction and column direction, a common electrode, and a first photo-alignment film, a second substrate disposed opposite to the first substrate, the second substrate including a second photo-alignment film, a liquid crystal layer disposed between the first substrate and the second substrate, the liquid crystal layer including a liquid crystal molecule having a negative dielectric anisotropy, and a plurality of spacers that keep an interval between the first substrate and the second substrate constant. The first substrate and the second substrate are formed such that a rate of change is larger than 6.25% in one of the plurality of spacers, the rate of change indicating a rate of an amount of change to a reference height, the amount of change indicating a difference between the reference height and a height after pushing and bonding of the first substrate and the second substrate to each other, the reference height indicating an original height before bonding of the first substrate and the second substrate to each other.

The above general aspect may include one or more of the following features. The rate of change may be larger than 6.25% and smaller than 11.25%.

In another general aspect, the a liquid crystal display device of the instant application includes a first substrate including a plurality of gate lines extending in a row direction, a plurality of data lines extending in a column direction, a plurality of pixel electrodes each of which is disposed according to each of a plurality of pixel regions arrayed in the row direction and column direction, a common electrode, and a first photo-alignment film, a second substrate disposed opposite to the first substrate, the second substrate including a second photo-alignment film, a liquid crystal layer disposed between the first substrate and the second substrate, the liquid crystal layer including a liquid crystal molecule having a negative dielectric anisotropy, and a plurality of spacers that keep an interval between the first substrate and the second substrate constant. The first substrate and the second substrate are formed such that an amount of change is larger than 0.25 μm in one of the plurality of spacers, the amount of change indicating a difference between an original height before bonding of the first substrate and the second substrate to each other and a height after pushing and bonding of the first substrate and the second substrate to each other.

The above general aspect may include one or more of the following features. The amount of change may be larger than 0.25 μm and smaller than 0.45 μm.

The plurality of spacers may include a first spacer and a second spacer lower than the first spacer in height. The amount of change may be smaller than a difference in height between the first spacer and the second spacer.

In another general aspect, a method for producing a liquid crystal display device. The liquid crystal display device includes a first substrate including a plurality of gate lines extending in a row direction, a plurality of data lines extending in a column direction, a plurality of pixel electrodes each of which is disposed according to each of a plurality of pixel regions arrayed in the row direction and column direction, and a common electrode, a second substrate disposed opposite to the first substrate, a liquid crystal layer disposed between the first substrate and the second substrate, the liquid crystal layer including a liquid crystal molecule having a negative dielectric anisotropy, and a plurality of spacers that keep an interval between the first substrate and the second substrate constant.

The method includes performing a photo-alignment treatment on a first alignment film formed on the first substrate and a second alignment film formed on the second substrate; and pressurizing the first substrate and the second substrate such that a rate of change is larger than 6.25% in one of the plurality of spacers, the rate of change indicating a rate of an amount of change to a reference height, the amount of change indicating a difference between the reference height and a height after pushing and bonding of the first substrate and the second substrate to each other, the reference height indicating an original height before bonding of the first substrate and the second substrate to each other.

With the configuration of the liquid crystal display device according to the present disclosure, the bright spot generation caused by the performance of the predetermined temperature cycle can be suppressed in the IPS-system liquid crystal display device in which the photo-alignment film and the negative liquid crystal are used.

### BRIEF DESCRIPTION OF THE DRAWINGS

FIG. 1 is a plan view illustrating a schematic configuration of a liquid crystal display device according to an exemplary embodiment of the present disclosure;

FIG. 2 is a plan view illustrating a configuration of pixel region;

FIG. 3 is a sectional view taken along line A-A in FIG. 2;

FIG. 4 schematically illustrates a principle that the bright spot is generated by the temperature cycle test;

FIGS. 5A and 5B are sectional views schematically illustrating an amount of change Δh in height of each of the cell gap and spacer;

FIG. 6 is a graph illustrating the relationship between the amount of change Δh and the bright spot generation;

FIGS. 7A and 7B are sectional views schematically illustrating the amount of change Δh in height of each of the cell gap and spacer;

FIG. 8 is a graph in which the amount of change Δh in FIG. 6 is converted into the rate of change hr; and

FIG. 9 is a graph illustrating the relationship between the reference height h0 and the amount of change Δh.

### DETAILED DESCRIPTION

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

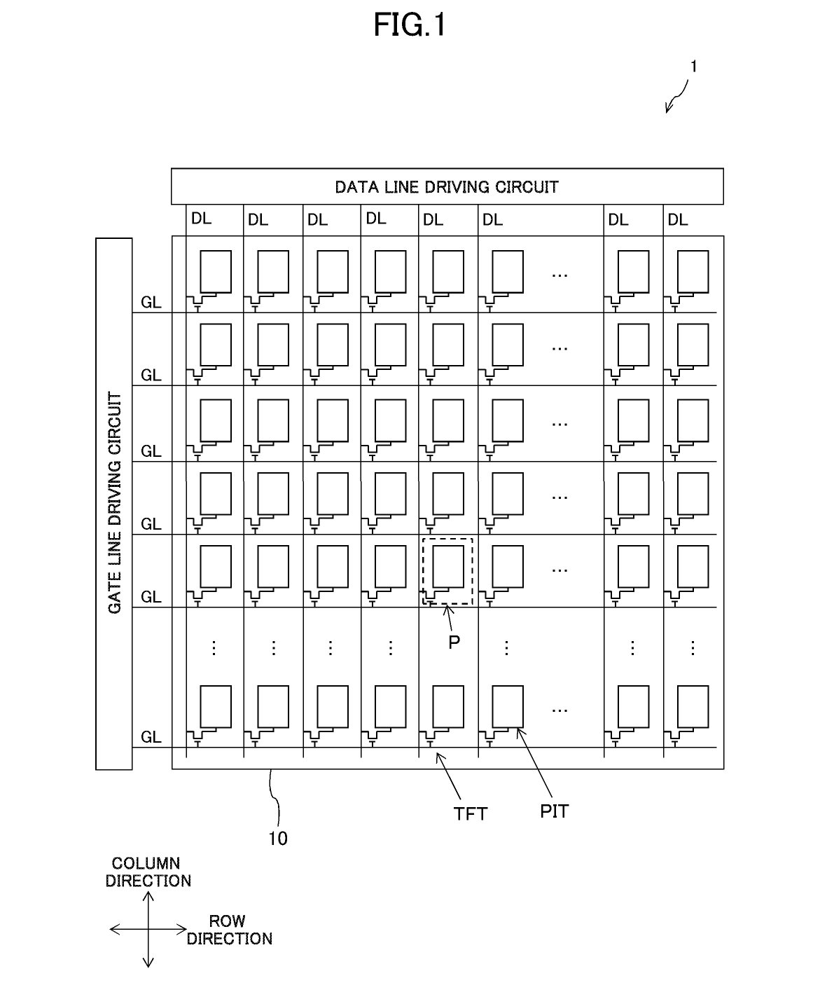

FIG. 1 is a plan view illustrating a schematic configuration of a liquid crystal display device according to an exemplary embodiment of the present disclosure. Liquid crystal display device 1 includes display panel 10 that displays an image, a driving circuit (a data line driving circuit and a gate line driving circuit) that drives display panel 10, a control circuit (not illustrated) that controls the driving circuit, and a backlight (not illustrated) that irradiates display panel 10 with light from a rear surface side. In a display region of display panel 10, a plurality of pixel regions P each of which is surrounded by two gate lines GL adjacent to each other and two data lines DL adjacent to each other are arrayed in a matrix form in row and column directions. Hereinafter, a direction in which gate line GL extends is referred to as the row direction, and a direction in which data line DL extends is referred to as the column direction.

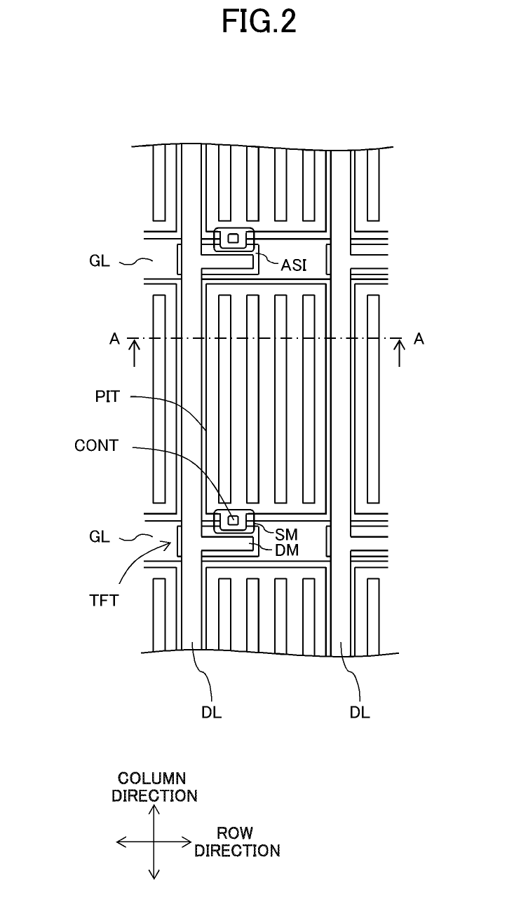

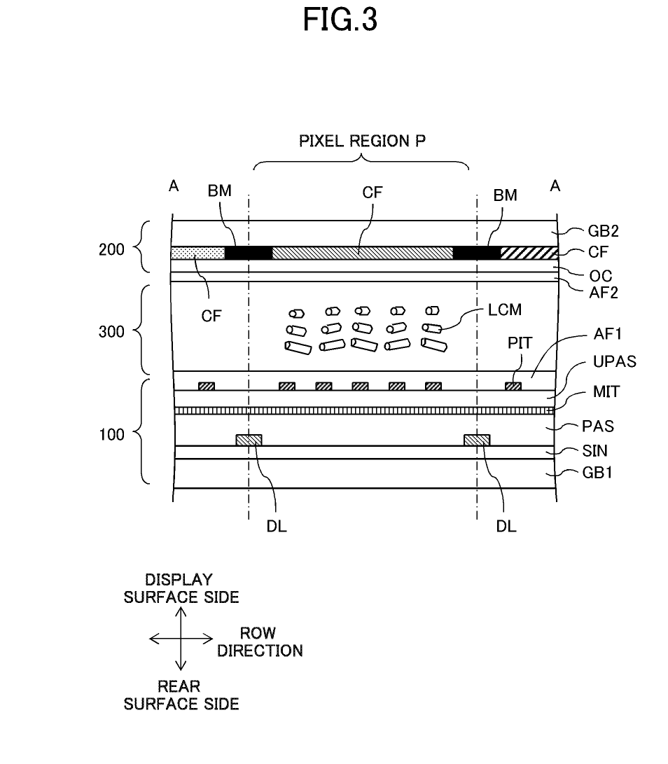

FIG. 2 is a plan view illustrating a configuration of pixel region P. FIG. 3 is a sectional view taken along line A-A in FIG. 2. A specific configuration of display panel 10 will be described with reference to FIGS. 2 and 3.

Pixel electrode PIT made of a transparent conductive film such as Indium Tin Oxide (ITO) is formed in pixel region P. Pixel electrode PIT has an opening (for example, a slit), and is formed into a stripe shape. Thin film transistor TFT includes semiconductor layer ASI formed on insulator SIN (see FIG. 3) and drain electrode DM and source electrode SM, which are formed on semiconductor layer ASI (see FIG. 2). Drain electrode DM is electrically connected to data line DL, and source electrode SM is electrically connected to pixel electrode PIT through contact hole CONT. In the whole display region, common electrode MIT (see FIG. 3) is formed in common with each pixel region P. Pixel electrode PIT and common electrode MIT are not limited to the above configurations. For example, pixel electrode PIT and common electrode MIT may mutually be formed into a comb tooth shape. Pixel electrode PIT and common electrode MIT may be formed in an identical layer, or pixel electrode PIT may be formed in a lower layer while common electrode MIT may be formed in an upper layer.

As illustrated in FIG. 3, display panel 10 includes thin film transistor substrate 100 (hereinafter, referred to as a TFT substrate) (first substrate) disposed on the rear surface side, color filter substrate 200 (hereinafter, referred to as a CF substrate) (second substrate) disposed on the display surface side, and liquid crystal layer 300 sandwiched between TFT substrate 100 and CF substrate 200.

In TFT substrate 100, gate line GL (not illustrated in FIG. 3) is formed on glass substrate GB1, and insulator SIN is formed so as to cover gate line GL. Data line DL is formed on insulator SIN, and insulator PAS is formed so as to cover data line DL. Common electrode MIT is formed on insulator PAS, and insulator UPAS is formed so as to cover common electrode MIT. Pixel electrode PIT is formed on insulator UPAS, and alignment film AF1 is formed so as to cover pixel electrode PIT. Although not illustrated, a polarizing plate and the like are formed on TFT substrate 100. A layered structure of each portion constituting pixel region P is not limited to the configuration in FIG. 3, but any known configuration can be applied to the layered structure.

In CF substrate 200, black matrix BM and colored portion CF (for example, a red portion, a green portion, and a blue portion) are formed on glass substrate GB2, and overcoat layer OC is formed so as to cover black matrix BM and colored portion CF. Alignment film AF2 is formed on overcoat layer OC. Although not illustrated, a polarizing plate and the like are formed on CF substrate 200.

As can be seen from FIGS. 2 and 3, liquid crystal display device 1 has a configuration of what is called an IPS (In-Plane Switching) system. Note that IPS-system liquid crystal display device 1 is not limited to the configuration illustrated in FIGS. 2 and 3.

Liquid crystal molecule LCM (negative liquid crystal) having a negative dielectric anisotropy is sealed in liquid crystal layer 300. For example, MLC-3006 (product of Merck Ltd.) and the like can be used as the negative liquid crystal.

Alignment films AF1, AF2 are alignment films subjected to the photo-alignment treatment, namely, alignment films (photo-alignment films) formed by irradiation with an ultraviolet ray having predetermined energy. A known method can be adopted as the photo alignment method.

A method for driving liquid crystal display device 1 will briefly be described below. The gate line driving circuit supplies a gate voltage (a gate-on voltage and a gate-off voltage) for scan to gate line GL. The data line driving circuit supplies a data voltage for video to data line DL. When the gate-on voltage is supplied to gate line GL, thin film transistor TFT is put into an on state, the data voltage supplied to data line DL is transferred to pixel electrode PIT through drain electrode DM and source electrode SM. The common electrode driving circuit (not illustrated) supplies a common voltage (Vcom) to common electrode MIT. Common electrode MIT overlaps pixel electrode PIT with insulator UPAS interposed therebetween. The opening (slit) is formed in pixel electrode PIT. Therefore, liquid crystal molecule LCM is driven by an electric field from pixel electrode PIT to common electrode MIT through liquid crystal layer 300 and the slit of pixel electrode PIT. Liquid crystal molecule LCM is driven to control a transmittance of light transmitted through liquid crystal layer 300, and thus an image is displayed. In cases where a color image is displayed, a desired data voltage is supplied to data lines DL(R), DL(G), DL(B) respectively connected to pixel electrodes PIT in pixel regions P corresponding to the red portion, green portion, and blue portion, which are made of vertical-stripe-shaped color filters. The method for driving liquid crystal display device 1 is not limited to the above method, but a known method can be adopted.

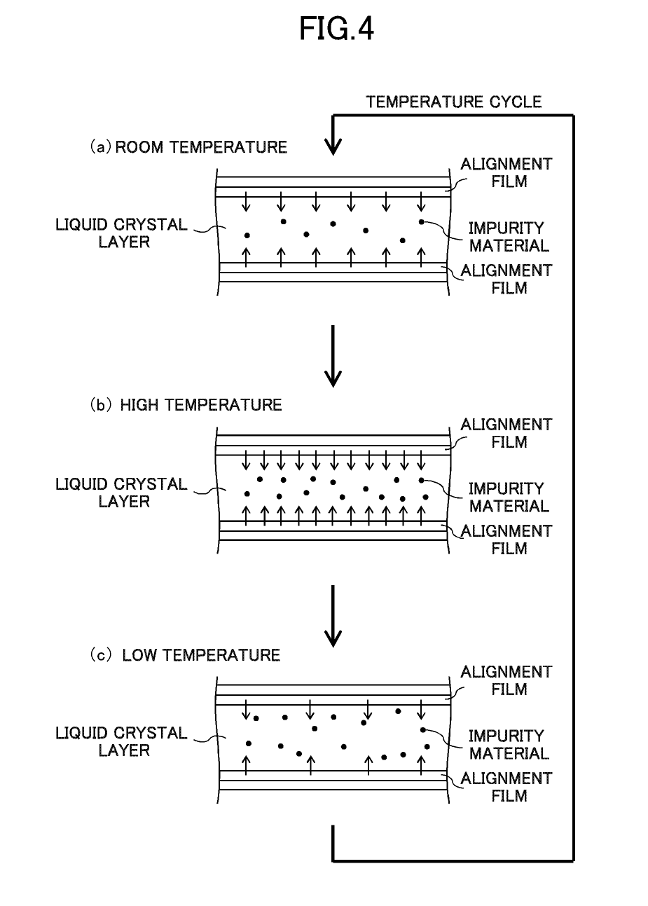

As described above, in the IPS-system liquid crystal display device in which the photo-alignment film and the negative liquid crystal are used, there is the problem in that the bright spot is generated in the display region when the predetermined temperature cycle (for example, room temperature→high temperature→low temperature→room temperature) test is repeated. It is considered that, in the temperature cycle test, an impurity material contained in the alignment film is deposited after eluted into the liquid crystal layer, thereby generating the bright spot. FIG. 4 schematically illustrates a principle that the bright spot is generated by the temperature cycle test. At room temperature (see part (a) of FIG. 4), the impurity material contained in the alignment film is eluted into the liquid crystal layer. Next, at a high temperature (see part (b) of FIG. 4), a large amount of impurity material contained in the alignment film is eluted and accumulated in the liquid crystal layer, and saturated in the liquid crystal layer. At a low temperature (see part (c) of FIG. 4), the impurity material is deposited. It is considered that the deposited impurity material appears as the bright spot. Further, it is considered that in cases where a molecular weight of the impurity material is close to that of the liquid crystal molecule, compatibility with the liquid crystal molecule is improved, and the impurity material is easily eluted into the liquid crystal. Resultantly, the impurity material is deposited by the repetition of the temperature cycle. That is, the impurity material is easily deposited when the impurity material has the molecular weight between 200 and 600 (inclusive), which is a normal molecular weight of the liquid crystal molecule, in particular the molecular weight between 350 and 450 (inclusive).

A method for suppressing the bright spot generation will be described below. The temperature cycle test was performed on a plurality of display panels to inspect the bright spot generation. Resultantly, it is found that the bright spot generation is correlated with a pushing amount (expressed by an amount of change Δh) of a cell gap (a thickness of the liquid crystal layer). It is assumed that a reference height is an interval h0 (an original height of the spacer) between TFT substrate 100 and CF substrate 200 in the state in which the substrates are disposed while a spacer (photo spacer) keeping the interval between the substrates constant is interposed between the substrates before the substrates are bonded together in a production process (bonding process). At this point, the amount of change Δh means a pushing amount (the amount of change in height of each of cell gap and spacer) when the substrates are pressurized such that the reference height is lowered. For example, in CF substrate 200, the spacer is formed so as to overlap with black matrix BM in planar view. There is no limitation to a shape of the spacer shape and a spacer forming method, but a known configuration can be applied.

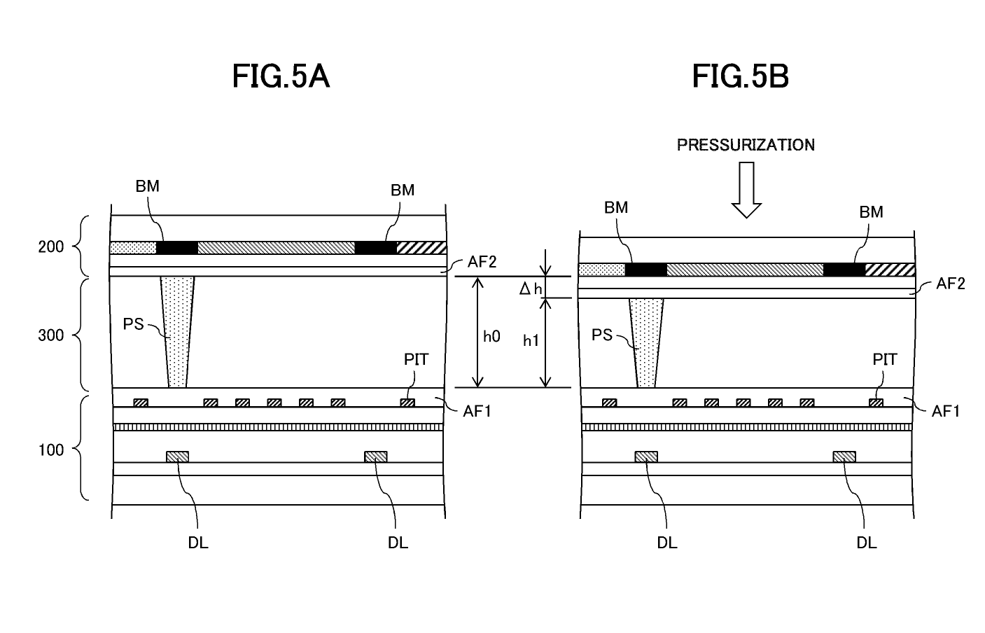

FIG. 5 is a sectional view schematically illustrating an amount of change in height of each of the cell gap and spacer PS. FIG. 5A illustrates a state in which TFT substrate 100 and CF substrate 200 are disposed with spacer PS interposed therebetween (pre-adhesion state). In the state of FIG. 5A, TFT substrate 100 and CF substrate 200 are not pressurized, but the cell gap and spacer PS have reference height h0. FIG. 5B illustrates a state in which reference height h0 changes from the state in FIG. 5A, because TFT substrate 100 and CF substrate 200 are pressurized (post-adhesion state). In the state of FIG. 5B, reference height h0 is decreased by Δh by the pressurization of both the substrates, and heights of the cell gap and spacer PS become h1(h1=h0−Δh).

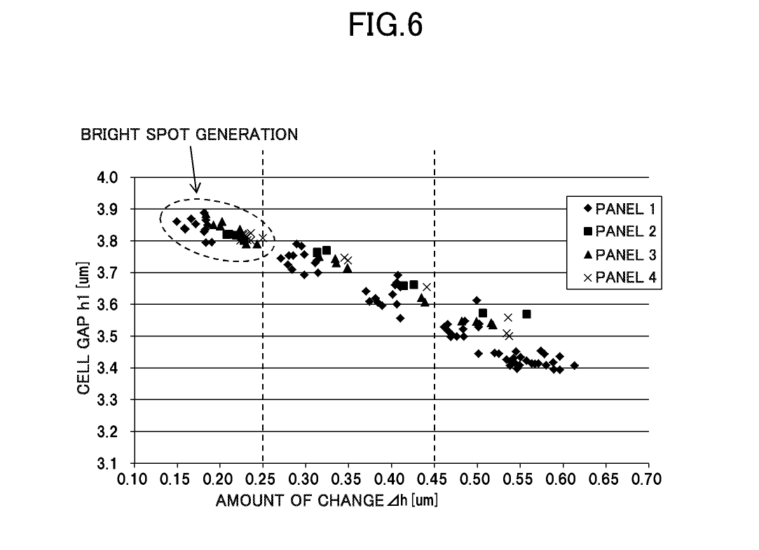

Next, a result of inspecting a relationship between the amount of change Δh and the bright spot generation will be described. FIG. 6 is a graph illustrating the relationship between the amount of change Δh and the bright spot generation. Because the cell gap and spacer PS have the identical height, the cell gap will be described below as an example. Reference height h0 of cell gap was set to 4.0 μm, and the temperature cycle test was performed on four kinds of display panels by arbitrarily changing the amount of change Δh, and whether the bright spot was generated was inspected. Any one or a plurality of points was extracted with respect to each display panel, and whether the bright spot was generated was inspected.

The inspection results shows that the bright spot can visually be recognized for the display panel having the amount of change Δh of 0.25 μm or less, and that the bright spot cannot visually be recognized for the display panel having the amount of change Δh larger than 0.25 μm. It is found that the bright spot generation can be suppressed by setting the amount of change Δh to 0.25 μm or more.

Spacer PS may include two kinds of spacers having different heights. Specifically, spacer PS may include main spacer PS1 (first spacer) that is in contact with TFT substrate 100 and CF substrate 200 in a normal state and sub-spacer PS2 (second spacer) that is not in contact with one of TFT substrate 100 and CF substrate 200 in the normal state but is in contact both TFT substrate 100 and CF substrate 200 when display panel 10 is deformed. The provision of sub-spacer PS2 improves a pressure-resistant property, and suppresses generation of a bubble at a low temperature.

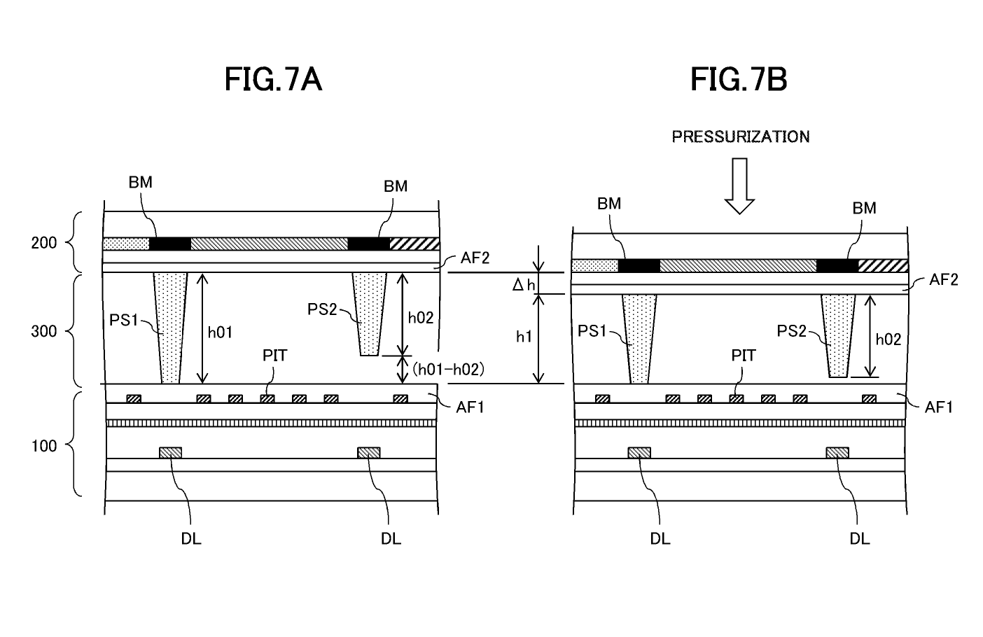

FIG. 7 is a sectional view schematically illustrating the amount of change in height of each of the cell gap and spacer PS (main spacer PS1 and sub-spacer PS2). As illustrated in FIG. 7A, the reference height of main spacer PS1 is set to h01, and the reference height of sub-spacer PS2 is set to h02. As illustrated in FIG. 7B, preferably the amount of change Δh is set to a value smaller than a difference (h01−h02) between reference height h01 of main spacer PS1 and reference height h02 of sub-spacer PS2 (Δh<(h01−h02)).

In the amount of change Δh, the lower limit can be set to 0.25 μm as described above (see FIG. 6). In the amount of change Δh, an upper limit can be set to (h01−h02) in consideration of sub-spacer PS2 (see FIG. 7). That is, preferably the amount of change Δh is set so as to satisfy 0.25−m<Δh<(h01−h02) μm. For example, in cases where height h01 of main spacer PS1 is set to 4.0 μm while height h02 of sub-spacer PS2 is set to 3.55 μm, preferably the amount of change Δh is set so as to satisfy 0.25 μm<Δh<0.45 μm as illustrated in FIG. 6.

At this point, it is considered that the amount of change Δh is correlated (proportional relation) with reference height h0 of the cell gap (spacer PS). Therefore, in the inspection, reference height h0 of cell gap (spacer PS) is set to 4.0 μm by way of example. On the other hand, in cases where the reference height h0 is set to a value different from 4.0 μm, preferably the lower limit and upper limit of the amount of change Δh are set to values according to reference height h0.

In order to generalize the relationship between the amount of change Δh and the bright spot generation irrespective of the reference height h0, a rate (rate of change) of the amount of change Δh to the reference height h0 is calculated, and the relationship between the rate of change and the bright spot generation will be discussed. The rate of change hr (%) can be calculated from an equation of hr=(Δh/h0)×100.

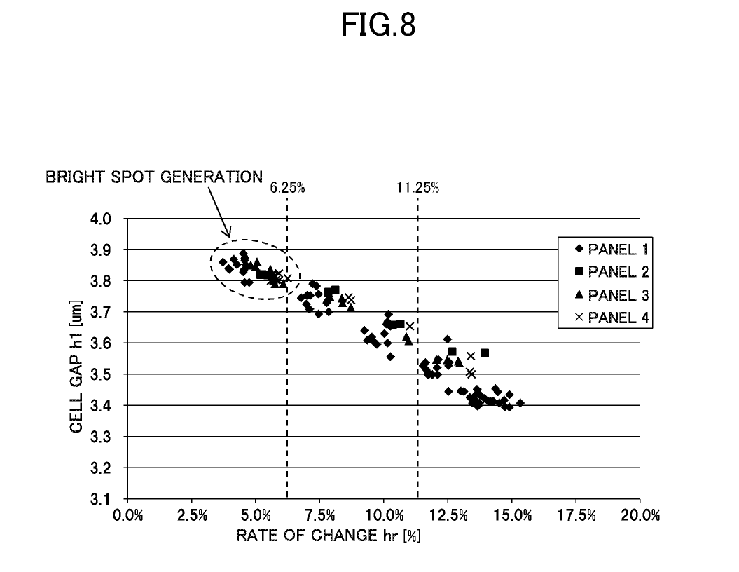

FIG. 8 is a graph in which the amount of change Δh in FIG. 6 is converted into the rate of change hr. As illustrated in FIG. 8, the rate of change hr becomes 6.25% (=0.25 μm/4.0 μm×100) in cases where the amount of change Δh is the lower limit 0.25 μm, and the rate of change hr becomes 11.25% (=0.45 μm/4.0 μm×100) in cases where the amount of change Δh is the upper limit of 0.45 μm. As is clear from the graph in FIG. 8, the bright spot can be recognized in the display panel having the rate of change hr of 6.25% or less, and the bright spot cannot be recognized in the display panel having the rate of change hr larger than 6.25%. Resultantly, in liquid crystal display device 1, preferably the rate of change hr is set to a value larger than 6.25%, and preferably a value, which is larger than 6.25% and smaller than 11.25% (6.25%<hr<11.25%).

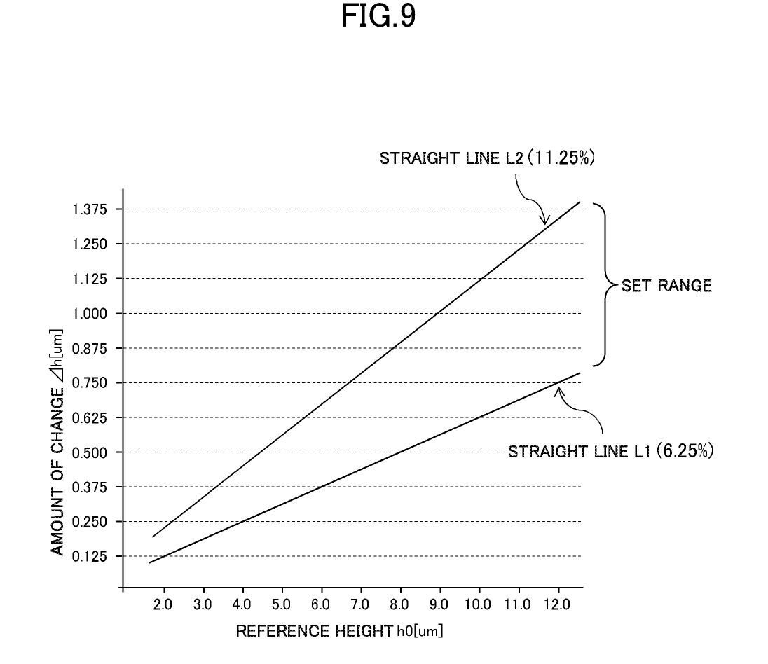

FIG. 9 is a graph illustrating the relationship between the reference height h0 and the amount of change Δh. In FIG. 9, straight line L1 indicates the lower limit of 6.25% of the rate of change hr, and straight line L2 indicates the upper limit of 11.25% of the rate of change hr. That is, FIG. 9 illustrates a range in which the amount of change Δh should be set with respect to the reference height h0.

For the display panel in which reference height (original height) h0 of spacer PS is set to 3.0 μm, preferably the amount of change Δh is set to a range of 0.1875 μm (=3.0×0.0625) to 0.3375 μm (=3.0×0.1125). For the display panel in which reference height (original height) h0 of spacer PS is set to 5.0 μm, preferably the amount of change Δh is set to a range of 0.3125 μm (=5.0×0.0625) to 0.5625 μm (=5.0×0.1125).

In the liquid crystal display device 1, a process of applying a pressure according to the amount of change Δh is included in addition to a known production process. The pressurization process is included in a process of bonding TFT substrate 100 and CF substrate 200 together. That is, in the pressurization process, TFT substrate 100 and CF substrate 200 are pressurized such that the rate of change hr, which indicates the amount of change Δh in height after the pushing and bonding of the substrates to each other in spacer PS with respect to the original height (reference height h0) before the bonding of the substrates to each other, is larger than 6.25% and smaller than 11.25%. Otherwise, in the pressurization process, TFT substrate 100 and CF substrate 200 are pressurized such that the amount of change Δh, which indicates the difference between the original height (reference height h0) before the bonding of the substrates to each other in spacer PS and height h1 after the pushing and bonding of the substrates to each other, is larger than 0.25 μm and smaller than 0.45 μm.

According to the configuration and production method of liquid crystal display device 1, the bright spot generation caused by the predetermined temperature cycle test can be suppressed in the IPS-system liquid crystal display device in which the photo-alignment film and the negative liquid crystal are used.

Although exemplary embodiments of the present disclosure are described above, the present disclosure is not limited to these exemplary embodiments. It is noted that exemplary embodiments properly changed from the exemplary embodiments described above by those skilled in the art without departing from the scope of the present disclosure are included in the present disclosure.

What is claimed is:

1. A liquid crystal display device comprising:
a first substrate including a plurality of gate lines extending in a row direction, a plurality of data lines extending in a column direction, a plurality of pixel electrodes each of which is disposed according to each of a plurality of pixel regions arrayed in the row direction and column direction, a common electrode, and a first photo-alignment film;
a second substrate disposed opposite to the first substrate, the second substrate including a second photo-alignment film;
a liquid crystal layer disposed between the first substrate and the second substrate, the liquid crystal layer including a liquid crystal molecule having a negative dielectric anisotropy; and
a plurality of spacers that keep an interval between the first substrate and the second substrate constant,
wherein the first substrate and the second substrate are formed such that a rate of change is larger than 6.25% in one of the plurality of spacers, the rate of change indicating a rate of an amount of change to a reference height, the amount of change indicating a difference between the reference height and a height after pushing and bonding of the first substrate and the second substrate to each other, the reference height indicating an original height before bonding of the first substrate and the second substrate to each other.

2. The liquid crystal display device according to claim 1, wherein the rate of change is larger than 6.25% and smaller than 11.25%.

3. A liquid crystal display device comprising:
a first substrate including a plurality of gate lines extending in a row direction, a plurality of data lines extending in a column direction, a plurality of pixel electrodes each of which is disposed according to each of a plurality of pixel regions arrayed in the row direction and column direction, a common electrode, and a first photo-alignment film;
a second substrate disposed opposite to the first substrate, the second substrate including a second photo-alignment film;
a liquid crystal layer disposed between the first substrate and the second substrate, the liquid crystal layer including a liquid crystal molecule having a negative dielectric anisotropy; and
a plurality of spacers that keep an interval between the first substrate and the second substrate constant,
wherein the first substrate and the second substrate are formed such that an amount of change is larger than 0.25 μm in one of the plurality of spacers, the amount of change indicating a difference between an original height before bonding of the first substrate and the second substrate to each other and a height after pushing and bonding of the first substrate and the second substrate to each other.

4. The liquid crystal display device according to claim 3, wherein the amount of change is larger than 0.25 μm and smaller than 0.45 μm.

5. The liquid crystal display device according to claim 1, wherein
the plurality of spacers includes a first spacer and a second spacer lower than the first spacer in height, and
the amount of change is smaller than a difference in height between the first spacer and the second spacer.

6. The liquid crystal display device according to claim 3, wherein
the plurality of spacers includes a first spacer and a second spacer lower than the first spacer in height, and
the amount of change is smaller than a difference in height between the first spacer and the second spacer.

7. A method for producing a liquid crystal display device, the liquid crystal display device including:
a first substrate including a plurality of gate lines extending in a row direction, a plurality of data lines extending in a column direction, a plurality of pixel electrodes each of which is disposed according to each of a plurality of pixel regions arrayed in the row direction and column direction, and a common electrode;
a second substrate disposed opposite to the first substrate;
a liquid crystal layer disposed between the first substrate and the second substrate, the liquid crystal layer including a liquid crystal molecule having a negative dielectric anisotropy; and
a plurality of spacers that keep an interval between the first substrate and the second substrate constant,
the method comprising:
performing a photo-alignment treatment on a first alignment film formed on the first substrate and a second alignment film formed on the second substrate; and
pressurizing the first substrate and the second substrate such that a rate of change is larger than 6.25% in one of the plurality of spacers, the rate of change indicating a rate of an amount of change to a reference height, the amount of change indicating a difference between the reference height and a height after pushing and bonding of the first substrate and the second substrate to each other, the reference height indicating an original height before bonding of the first substrate and the second substrate to each other.
